(19) United States
(12) Patent Application Publication
(10) Pub. No.: US 2016/0335985 A1
(43) Pub. Date: Nov. 17, 2016

(54) RENDERING HIGH BIT DEPTH GRAYSCALE IMAGES USING GPU COLOR SPACES AND ACCELERATION

(71) Applicant: Box, Inc., Los Altos, CA (US)

(72) Inventors: Cody D. Ebberson, San Francisco, CA (US); Reshma K. Ebberson, San Francisco, CA (US)

(73) Assignee: Box, Inc., Los Altos, CA (US)

(21) Appl. No.: 14/712,831

(22) Filed: May 14, 2015

(51) Int. Cl. G09G 5/02; G09G 5/10; G06T 7/00; G06T 1/20

(52) U.S. Cl. CPC G09G 5/02; G06T 1/20; G09G 5/10; G06T 7/0051; G09G 2370/02

(57) ABSTRACT

Methods and systems for graphics rendering using a web browser. Embodiments commence upon receipt at a cloud-based collaboration server, a request to render a high bit depth image on a user device using a browser and a graphics processing unit. The graphics processing unit is configurable to render a display image based on a color space. The cloud-based collaboration server transmits a high bit depth image to the user device and a sending module sends instructions to be executed by the browser on the user device. The sent instructions comprise one or more first GPU commands that serve for rendering images using the graphics processing unit, wherein at least some of the GPU commands map the pixel data array to a color space, and some of the GPU commands map the pixel data array to the color space to generate a remapped grayscale image.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

This disclosure relates to the field of computer graphics rendering using a web browser, and more particularly to techniques for rendering high bit depth grayscale images using graphics processor unit (GPU) color spaces.

### BACKGROUND

The proliferation of cloud-based services and platforms continues to increase. Specifically, cloud-based content management services and platforms have impacted the way personal and corporate information is stored, and has also impacted the way personal and corporate information is shared and managed. One benefit of using a cloud-based service (e.g., content storage service) is for access to content from anywhere and any device through a web browser. However, web browser applications and most user device displays (e.g., laptops, smart phone displays, etc.) are limited in their ability to display high bit depth (HBD) images. These limitations often limit the applicability of cloud-based services to environments involving HBD images. For example, medical images from various medical imaging modalities such as X-ray, magnetic resonance imaging (MRI), and computed tomography (CT) can comprise between 12 and 16 bits per pixel, which corresponds to 4,096 to 65,536 possible shades of grayscale per pixel. In some cases, medical imaging in certain patient studies can comprise thousands of such HBD images.

Some legacy approaches for displaying medical images and other HBD images implement dedicated and/or proprietary computing systems with specialized graphics accelerators and displays. Such approaches, however, require costly on-premises hardware infrastructure and software, and do not include the aforementioned accessibility and collaboration features of a cloud-based service using web browsers and mobile devices. Other legacy attempts rely on general purpose CPUs and general purpose CPU computer languages to render images. However, approaches that rely on general purpose CPUs to render images fail to achieve suitable performance. Referring again to the aforementioned medical imaging scenario, a single image rendering operation would need to process and render the HBD images (e.g., an 8000 x 8000 pixel X-ray image) on a pixel-by-pixel basis, resulting in extremely long rendering times and unacceptable user experiences.

The legacy technological approach of custom graphics hardware suffers from an utter lack of portability to modern user terminals (e.g., laptops, smart phones), while the naive browser approach using general purpose CPUs and general purpose CPU computer languages to render images suffer from severely limited performance characteristics. The problem to be solved is therefore rooted in technological limitations of the legacy approaches. Improved techniques, in particular improved application of technology, are needed to address the problem of performing fast and high resolution rendering of high bit depth grayscale images in a web browser having no native graphics and display hardware support for high bit depth grayscale. More specifically, the technologies applied in the aforementioned legacy approaches fail to achieve sought-after capabilities of the herein disclosed techniques for rendering high bit depth grayscale images using GPU color spaces and acceleration. What is needed is a technique or techniques to improve the application and efficacy of various technologies as compared with the application and efficacy of legacy approaches.

### SUMMARY

The present disclosure provides improved systems, methods, and computer program products suited to address the aforementioned issues with legacy approaches. More specifically, the present disclosure provides a detailed description of techniques used in systems, methods, and in computer program products for rendering high bit depth grayscale images using GPU color spaces and acceleration. Certain embodiments are directed to technological solutions for recasting a high resolution grayscale image into a texture color space that is supported by high performance GPU APIs such as WebGL, which embodiments advance the relevant technical fields, as well as advancing peripheral technical fields. The disclosed embodiments modify and improve over legacy approaches. In particular, practice of the disclosed techniques reduces use of computer memory, reduces demand for computer processing power, and reduces communication overhead needed for rendering high bit depth grayscale images using GPU color spaces and acceleration. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of high performance computer graphics as well as advances in the technical fields of distributed storage.

Embodiments commence upon receiving, at a cloud-based collaboration server, a request to render a high bit depth image on a user device using a browser and a graphics processing unit. The graphics processing unit is configurable to render a display image based on a color space. The cloud-based collaboration server transmits a high bit depth image to the user device and a sending module sends instructions to be executed by the browser on the user device. The sent instructions comprise one or more first GPU commands that serve for rendering images using the graphics processing unit, wherein at least some of the GPU commands map the pixel data array to a color space, and some of the GPU commands map the pixel data array to the color space to generate a remapped grayscale image.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

The drawings described below are for illustration purposes only. The drawings are not intended to limit the scope of the present disclosure. This patent or application file contains at least one drawing executed in color. Copies of this patent or patent application publication with color drawings will be provided by the U.S. Patent and Trademark Office upon request and payment of the necessary fee.

FIG. 1A depicts an environment in which embodiments of the present disclosure can operate.

FIG. 1B shows a system for rendering high bit depth grayscale images using GPU color spaces and acceleration, according to an embodiment.

FIG. 2 presents a view windowing technique as used in systems for rendering high bit depth grayscale images using GPU color spaces and acceleration, according to some embodiments.

FIG. 3A is an image processing flow as used in systems for rendering high bit depth grayscale images using GPU color spaces and acceleration, according to some embodiments.

FIG. 3B illustrates an image file transformation technique as used in systems for rendering high bit depth grayscale images using GPU color spaces and acceleration, according to some embodiments.

FIG. 4 depicts a user view change operation as invoked in systems for rendering high bit depth grayscale images using GPU color spaces and acceleration, according to some embodiments.

FIG. 5A and FIG. 5B depict system components as arrangements of computing modules that are interconnected so as to implement certain of the herein-disclosed embodiments.

FIG. 6A and FIG. 6B depict exemplary architectures of components suitable for implementing embodiments of the present disclosure, and/or for use in the herein-described environments.

### DETAILED DESCRIPTION

Some embodiments of the present disclosure address the problem of performing fast and high resolution rendering of 16-bit grayscale images in a web browser having no native graphics and display hardware support for 16-bit grayscale. Some embodiments are directed to approaches for recasting a high resolution grayscale image into a color space that is supported by high performance GPU APIs such as WebGL. More particularly, disclosed herein and in the accompanying figures are exemplary environments, systems, methods, and computer program products for rendering high bit depth grayscale images using GPU color spaces and acceleration.

### Overview

The proliferation of cloud-based services and platforms continues to increase. One benefit of using a cloud-based service (e.g., content storage service) is access to content from anywhere using any device through a web browser. However, web browser applications and common user device displays can be limited in displaying high bit depth (HBD) images, potentially limiting the application of cloud-based services to environments involving HBD images. For example, medical images from various medical imaging modalities such as X-ray, MRI, and CTs can comprise grayscale images with 16 bits per pixel in formats that are pervasive in medical imaging, such as the digital imaging and communications in medicine (DICOM) file format.

The techniques described herein do not rely on costly on-premise hardware infrastructure and software, yet do provide the aforementioned accessibility and collaboration features of a cloud-based service using web browsers and mobile devices. Further, the herein-disclosed techniques eliminate or reduce the use of scripting languages when rendering HBD images.

To address the need for performing fast and high resolution rendering of high-bit depth (e.g., 16-bit depth) grayscale images in a web browser (e.g., a browser having no native graphics and display hardware support for high bit depth grayscale), the techniques described herein discuss (1) allocating high bit depth grayscale pixel data to red and green components (e.g., the 8-bit red and 8-bit green components) of a respective pixel in a texture color space, (2) constructing an associated fragment shader to convert the texture color space back to grayscale at the full resolution of the display, and (3) sending the texture data and fragment shader directly to a GPU using a browser-based protocol for rendering images using a graphics processor (e.g., WebGL) to accomplish fast rendering of images from within a browser.

Various embodiments are described herein with reference to the figures. It should be noted that the figures are not necessarily drawn to scale and that the elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment. An aspect or an advantage described in conjunction with a particular embodiment is not necessarily limited to that embodiment and can be practiced in any other embodiments even if not so illustrated. Also, reference throughout this specification to “some embodiments” or “other embodiments” refers to a particular feature, structure, material, or characteristic described in connection with the embodiments as being included in at least one embodiment. Thus, the appearances of the phrase “in some embodiments” or “in other embodiments” in various places throughout this specification are not necessarily referring to the same embodiment or embodiments.

The appended figures discuss aspects in a succession as follows: (1) an environment in which embodiments of the present disclosure can operate, (2) a view windowing technique, (3) a high-performance image file transformation technique, (4) a representative user view change operation, and (5) a system for rendering high bit depth grayscale images using GPU color spaces and acceleration.

### Definitions

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

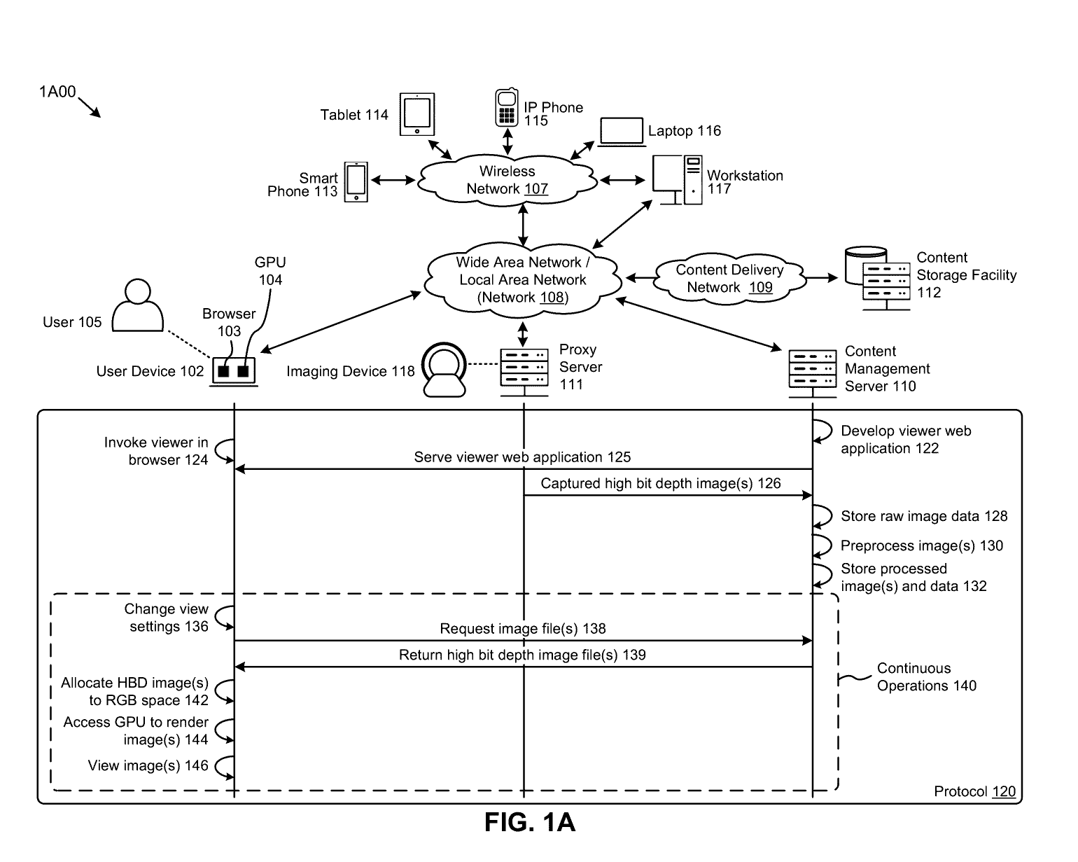

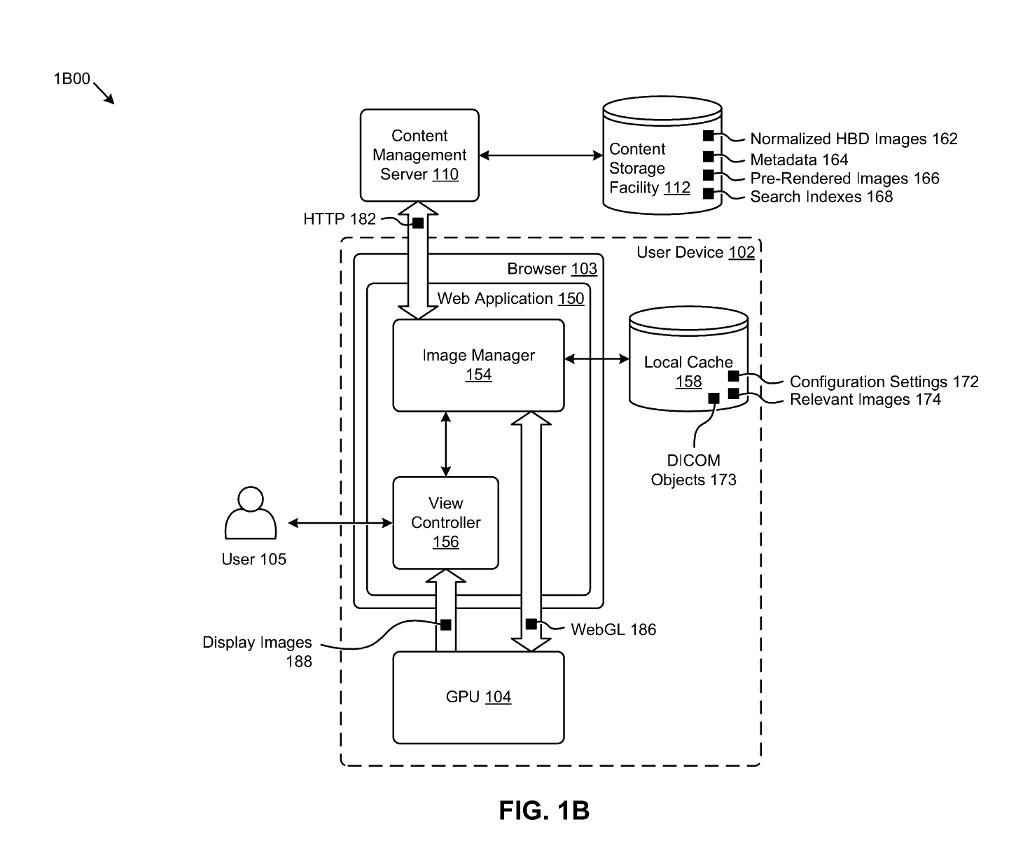

FIG. 1A depicts an environment 1A00 in which embodiments of the present disclosure can operate. As an option, one or more instances of environment 1A00 or any aspect thereof may be implemented in the context of the architecture and functionality of the embodiments described herein. Also, the environment 1A00 or any aspect thereof may be implemented in any desired environment.

As shown in FIG. 1A, environment 1A00 comprises various computing systems (e.g., servers and devices) interconnected by a wireless network 107, a network 108, and a content delivery network 109. The wireless network 107, the network 108, and the content delivery network 109 can comprise any combination of network ports to communicate with a wide area network (e.g., WAN), a local area network (e.g., LAN), a cellular network, a wireless LAN (e.g., WLAN), or any such means for enabling communication of computing systems. The wireless network 107, the network 108, and the content delivery network 109 can also collectively be referred to as the Internet. The content delivery network 109 can comprise any combination of a public network and a private network. More specifically, environment 1A00 comprises at least one instance of a content management server 110, at least one instance of a proxy server 111, and at least one instance of a content storage facility 112. The servers and storage facilities shown in environment 1A00 can represent any single computing system with dedicated hardware and software, multiple computing systems clustered together (e.g., a server farm), a portion of shared resources on one or more computing systems (e.g., a virtual server), or any combination thereof. For example, the content management server 110 and the content storage facility 112 can comprise a cloud-based content management platform that provides content management services.

Environment 1A00 further comprises an instance of a user device 102 that can represent one of a variety of other computing devices (e.g., a smart phone 113, a tablet 114, an IP phone 115, a laptop 116, a workstation 117, etc.) having software (e.g., a browser 103, an application, etc.) and hardware (e.g., a graphics processing unit or GPU 104) capable of processing and displaying information (e.g., web page, graphical user interface, etc.) on a display and communicating information (e.g., web page request, user activity, electronic files, etc.) over the wireless network 107, the network 108, and the content delivery network 109. As shown, the user device 102 can be operated by a user 105. Further, an imaging device 118 (e.g., MRI scanner, CT scanner, X-ray scanner, other imaging devices, etc.) can be coupled to the proxy server 111, and capture images that are sent to the proxy server 111 for various operations.

As shown, the user device 102, the proxy server 111, and the content management server 110 can exhibit a set of high-level interactions (e.g., operations, messages, etc.) in a protocol 120. Specifically, the protocol 120 can represent interactions in systems for rendering high bit depth grayscale images using GPU color spaces and acceleration. As shown, a viewer web application for a browser (e.g., browser 103) can be developed (see operation 122) and delivered (e.g., served by a web server) from the content management server 110 to the user device 102 (see message 125) in response to the user 105 invoking the viewer in a browser 103 (see operation 124). High bit depth images (e.g., 16-bit grayscale images in DICOM format) captured on the imaging device 118 can be securely sent (e.g., using HTTPS) by the proxy server 111 to the content management server 110 (see message 126). The images can be received by the content management server 110 and stored as original image data in a storage facility (see operation 128), such as content storage facility 112. In some cases, the content management server 110 can also preprocess the original images for various purposes (see operation 130). For example, various metadata from the original images can be extracted and used to construct new sets of metadata. Also, the original images can be used to pre-render images of various formats (e.g., JPEG) to support legacy browsers (e.g., having no mobile Javascript APIs). Further, the original images might be normalized (e.g., to a uniform DICOM structure) or normalized to a particular compression (e.g., run length encoding to RGB encoding) for later processing. The aforementioned processed images and data can then be stored (see operation 132).

When the user 105 changes the view settings from the viewer web application (see operation 136), a request for one or more image files is sent from the user device 102 to the content management server 110 (see message 138). For example, the user 105 might use the viewer to request a certain patient study recently captured at the imaging device 118 and comprising multiple (e.g., possibly hundreds) images grouped in a collection of image series or image stacks (e.g., one series for each view of the patient). Further, the user 105 can use the viewer web application to access the cloud-based service features of the content management server 110, such as searching, organizing, and collaboration. Responsive to the request (see message 138), the content management server 110 can return the related HBD image files (see message 139). The viewer web application operated in the browser 103 by the user device 102 can invoke software instructions (e.g., scripts, Javascript, WebGL commands, etc.) to prepare the images for display by allocating the HBD images to a color space, such as an RGB color space (see operation 142) that can be interpreted directly by the GPU 104 for rendering (see operation 144) and viewing (see operation 146). In one or more embodiments, for example, each 16-bit pixel in a grayscale file can be allocated to the 8-bit red and 8-bit green components of a respective pixel in a texture color space, and an associated fragment shader can be constructed or selected to convert the texture color space back to grayscale at the full resolution of the display when rendered by the GPU 104. In other embodiments, each high bit depth pixel in a grayscale image can be allocated to a selected set of color components to convert the texture color space back to grayscale at the full resolution of the display when rendered by the GPU 104. The color components can be organized as red, green, blue (RGB), or can be RGB plus alpha (RGBA), or can be BGR, or can by cyan, magenta, yellow, black (CMYK), or any other organization of color components.

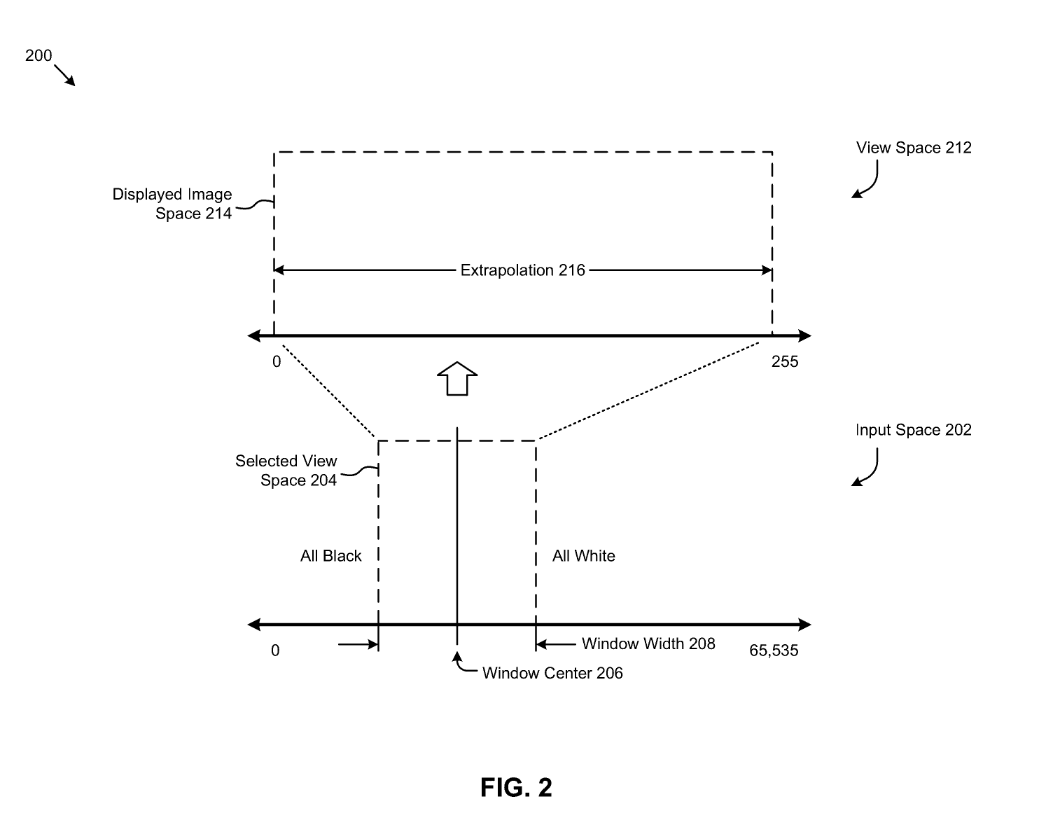

As shown, as the user 105 interacts with the viewer web application and changes various view settings (see operation 136), a set of continuous operations 140 comprising the shown portion of the aforementioned messages and operations will be executed. One embodiment of a system for implementing the techniques shown in protocol 120 for rendering high bit depth grayscale images using GPU color spaces and acceleration is shown in FIG. 2.

FIG. 1B shows a system 1B00 for rendering high bit depth grayscale images using GPU color spaces and acceleration. As an option, one or more instances of system 1B00 or any aspect thereof may be implemented in the context of the architecture and functionality of the embodiments described herein. Also, the system 1B00 or any aspect thereof may be implemented in any desired environment.

The system 1B00 shown in FIG. 1B presents an example embodiment of various modules for implementing the herein disclosed techniques. The system 1B00 can be operated by the user device 102 from within environment 1A00. Specifically, the user device 102 can operate a web application 150 comprising an image manager 154 and a view controller 156. As shown, the image manager 154 can access the content storage facility 112 through communications (e.g., HTTP protocol 182) with the content management server 110. The content storage facility 112 can store various content to be used by the image manager 154 and the web application 150, such as normalized HBD images 162, metadata 164, pre-rendered images 166, and search indexes 168. Other content may be stored and available for access by the web application 150. The image manager 154 can also access a local cache 158 that can store a set of configuration settings 172, a set of DICOM objects 173, and a set of relevant images 174. For example, the configuration settings 172 can specify the number of windows in the viewer, the maximum size of the local cache 158 (e.g., 400 MB), auto-open preferences, overlay preferences, pre-fetch preferences, and other preferences. Also, for example, the DICOM objects 173 can store the RGB texture and fragment shader information representing the respective HBD (e.g., 16-bit grayscale) images. Further, for example, the relevant images 174 can comprise a set of images recently viewed, a set of images related to studies associated with the user 105, and other sets of images. In some embodiments, the image manager 154 can continually check (e.g., with a web server and/or the content management server 110) for the availability and/or readiness of a certain study associated with the user 105 and build the set of relevant images 174 accordingly. Such sets of relevant images 174 can be stored in the local cache 158 in a hierarchical structure such as the following (shown in top-down order): studies, series, and objects (e.g., DICOM objects 173), or images (e.g., multi-frame images). The user 105 can interact with the view controller 156 of the web application 150 both visually, through a display on the user device 102, and/or mechanically, through various input devices (e.g., mouse, keyboard, touchpad, touchscreen, etc.) connected to the user device 102. For example, in one or more embodiments, the user 105 can invoke a view setting change (e.g., using a mouse click, mouse wheel change, roller wheel change, etc.) that can, in turn, invoke a communication between the view controller 156 and the image manager 154 to deliver the images and related information associated with the view change. The image manager 154 can get the image and information from the local cache 158 and/or the content management server 110 and submit the information to the GPU (e.g., using WebGL commands 186) for rendering one or more display images 188 to the display of the user device 102. When rendering images to a device display, the full resolution of the device display is desired to be used. A view windowing technique for optimizing the use of the device display resolution is discussed as pertains to FIG. 2.

FIG. 2 presents a view windowing technique 200 as used in systems for rendering high bit depth grayscale images using GPU color spaces and acceleration. As an option, one or more instances of view windowing technique 200 or any aspect thereof may be implemented in the context of the architecture and functionality of the embodiments described herein. Also, the view windowing technique 200 or any aspect thereof may be implemented in any desired environment.

The view windowing technique 200 shown in FIG. 2 presents one example of maximizing the resolution of a particular view of an HBD image for a given display (e.g., screen, monitor, etc.) resolution. Specifically, the example shown in FIG. 2 illustrates the mapping of an input space 202 comprising 16 bits per pixel (e.g., 0 to 65, 535 shades of grayscale) to a view space 212 comprising 8 bits per pixel (e.g., 0 to 255 shades of grayscale). Other bit depths for the input space 202 and the view space 212 (e.g., 10-bit high resolution displays) are possible. As shown, a selected view space 204 in the input space 202 can be defined by a window center 206 and a window width 208. The window center 206 and window width 208 can sometimes be described as associated with the brightness and contrast of the view. As an example, the selected view space 204 can be associated with a particular image (e.g., from within an MRI series) after being selected by a user. A particular image might be selected from among other images so as to best reveal details of a particular analysis area. In some cases, a window center and width pair can be established (e.g., predefined, calculated, etc.) and stored (e.g., in configuration settings 172 in local cache 158) for various studies and modalities. As shown, to then fully utilize the 8-bits per pixel in the view space 212, the view windowing technique 200 can perform an extrapolation 216 of the range of grayscale levels found in the selected view space 204 to the full range of levels available in view space 212 to produce a displayed image space 214. In some embodiments and implementations, the images associated with the selected view space 204 (e.g., DICOM image) and the displayed image space 214 (e.g., screen resolution image) can be represented by HTML <canvas> elements and associated scripts (e.g., Javascript). The embodiment shown in FIG. 2 is merely exemplary. Other embodiments implement different windowing techniques. In some cases, determining a window center can use a histogram and other statistical techniques to determine a window center and to determine a range of grayscale levels found in the selected view space 204 to produce a displayed image space 214.

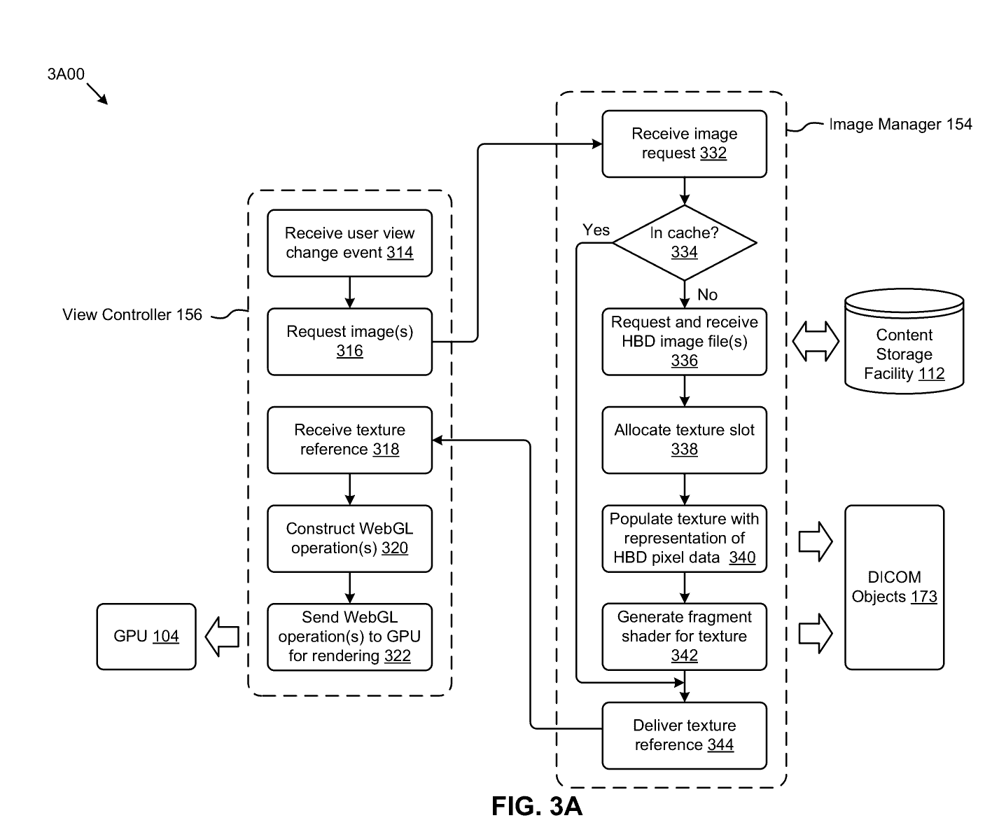

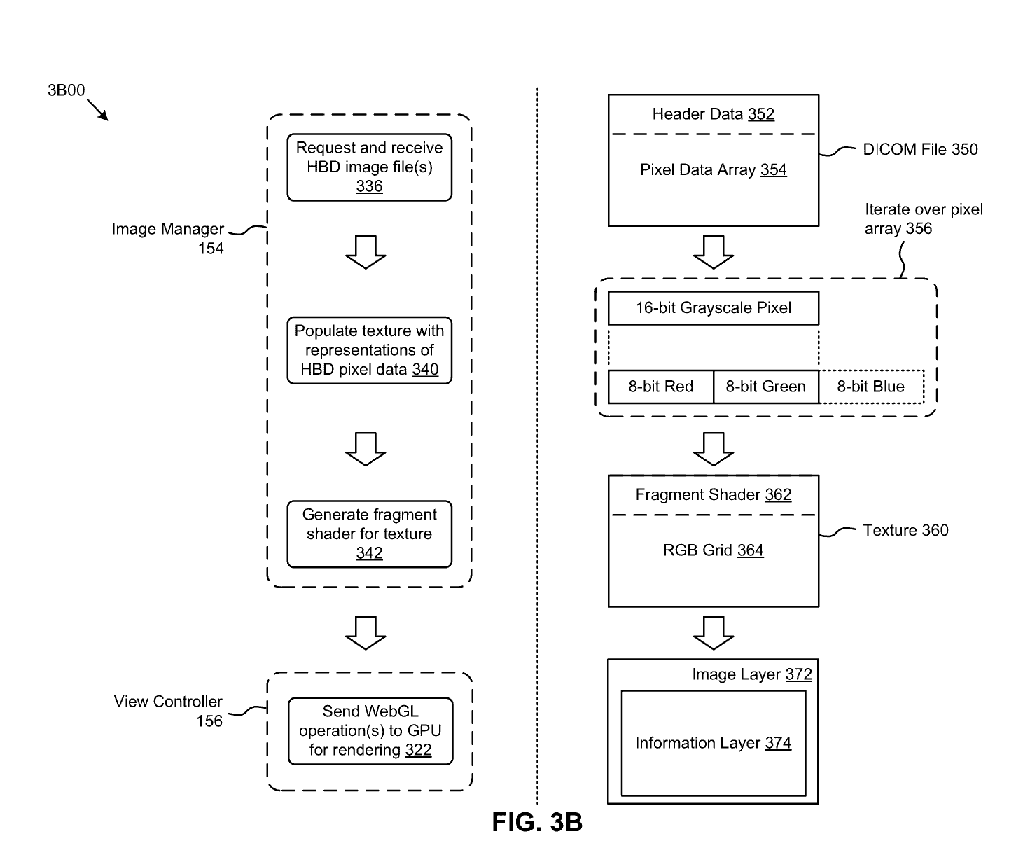

FIG. 3A is an image processing flow 3A00 as used in systems for rendering high bit depth grayscale images using GPU color spaces and acceleration. As an option, one or more instances of image processing flow 3A00 or any aspect thereof may be implemented in the context of the architecture and functionality of the embodiments described herein. Also, the image processing flow 3A00 or any aspect thereof may be implemented in any desired environment.

The image processing flow 3A00 shown in FIG. 3A shows a plurality of operations that can be executed by the view controller 156 and the image manager 154 described in FIG. 1B. For reference, the content storage facility 112, the set of DICOM objects 173, and the GPU 104 from FIG. 1B are also shown. Additional or fewer steps and/or other allocations of operations are possible. Specifically, the image processing flow 3A00 can be used in systems for rendering high bit depth grayscale images using GPU color spaces and acceleration. More specifically, the image processing flow 3A00 can start with the view controller 156 receiving a user view change event (see step 314), such as a mouse click, mouse wheel change, or roller wheel change. In response to the view change event, a request for one or more images can be sent to and received by the image manager 154 (see step 316 and step 332). The image manager 154 will check for all or a portion of the requested images in the local cache (see decision 334). If at least a portion of the requested images are not found locally (e.g., in local cache 158), the image manager 154 will request and receive one or more image files from the content storage facility 112 (see step 336). The image manager 154 can then allocate a texture slot (e.g., memory locations associated with GPU 104) for each HBD image received and populate the texture with a representation of the HBD pixel data (see step 338 and step 340). The image manager can further generate a fragment shader associated with each texture (see step 342). For example, each 16-bit pixel in a grayscale DICOM image file can be allocated to the 8-bit red and 8-bit green color components of a respective pixel in the texture, and the associated fragment shader can be constructed to convert the texture color space back to grayscale upon rendering. In some embodiments, for example, the fragment shader can also comprise the extrapolation 216 of the selected view space 204 to the displayed image space 214 (e.g., see the view windowing technique 200 shown in FIG. 2) to optimize the utilization use of the display resolution. The texture data and fragment shader data can be stored in an instance of the DICOM objects 173. A reference (e.g., handle) to the texture, and any references to other information can also be stored locally in cache and can be delivered to and received by the view controller 156 (see step 344 and step 318). The view controller 156 can then construct one or more WebGL operations (see step 320) to send to the GPU 104 for rendering (see step 322). More details related to the image file transformation associated with the image processing flow 3A00 are shown in FIG. 3B.

FIG. 3B illustrates an image file transformation technique 3B00 as used in systems for rendering high bit depth grayscale images using GPU color spaces and acceleration. As an option, one or more instances of image file transformation technique 3B00 or any aspect thereof may be implemented in the context of the architecture and functionality of the embodiments described herein. Also, the image file transformation technique 3B00 or any aspect thereof may be implemented in any desired environment.

The image file transformation technique 3B00 shown in FIG. 3B illustrates an example set of image representation structures corresponding to selected steps from the image processing flow 3A00. Specifically, as shown, a DICOM file 350 can be received by the image manager 154 (see step 336), comprising instances of header data 352 (e.g., patient information, test information, imaging device settings, etc.) and a pixel data array 354 (e.g., an array of 16-bit integers). In some cases, the image manager 154 can parse the DICOM file 350 (e.g., a binary file) to determine and/or precalculate a certain byte ordering (e.g., little endian, big endian, etc.). When the image manager 154 populates a texture with a representation of the HBD pixel data (see step 340), the image manager 154 can iterate over each 16-bit word in the pixel data array 354 and load the 16 bits of each pixel into the 8-bit red component and 8-bit green component of a respective texture pixel (see operation 356). The image manager 154 can then construct and attach a fragment shader 362 into an RGB grid 364 of the texture 360. In one or more embodiments and examples, the fragment shader 362 can include certain user preferences, the window width, the window center, the zoom level, the position, and other information. When the reference (e.g., handler) to the texture 360 is sent to the GPU (e.g., using WebGL) by the view controller 156, an image layer 372 and an information layer 374 is displayed for viewing. For example, the separate layers enable the information layer 374 (e.g., low bit density graphics) to be updated without changing the image layer 372 (e.g., high bit density images), increasing rendering speed and efficiency.

Strictly as an example, the following lines of code can be used in a fragment shader.

TABLE 1
WebGL “FragmentShader” code

| Line Number | Statement |
|---|---|
| 1 | medxt.ui.viewer.WebGLRenderer.fragmentShader = |
| 2 | ‘precision mediump float;’ + |
| 3 | ‘uniform sampler2D u_image;’ + |
| 4 | ‘uniform float u_windowLevel[2];’ + |
| 5 | ‘uniform float u_rescale[2];’ + |
| 6 | ‘uniform vec4 u_redTransform;’ + |
| 7 | ‘uniform vec4 u_blueTransform;’ + |
| 8 | ‘uniform vec4 u_greenTransform;’ + |
| 9 | ‘varying vec2 v_texCoord;’ + |
| 10 | ‘void main( ) {’ + |
| 11 | ‘vec4 tmp_raw = |
| | texture2D(u_image, v_texCoord).rgba;’ + |
| 12 | ‘float tmp_r = dot(tmp_raw, u_redTransform);’ + |
| 13 | ‘float tmp_g = dot(tmp_raw, u_greenTransform);’ + |
| 14 | ‘float tmp_b = dot(tmp_raw, u_blueTransform);’ + |
| 15 | ‘float tmp_center = u_windowLevel[0];’ + |
| 16 | ‘float tmp_width = u_windowLevel[1];’ + |
| 17 | ‘float out_r = (((tmp_r * u_rescale[0] + u_rescale[1]) − |
| | tmp_center) / tmp_width) + 0.5;’ + |
| 18 | ‘float out_g = (((tmp_g * u_rescale[0] + u_rescale[1]) − |
| | tmp_center) / tmp_width) + 0.5;’ + |
| 19 | ‘float out_b = (((tmp_b * u_rescale[0] + u_rescale[1]) − |
| | tmp_center) / tmp_width) + 0.5;’ + |
| 20 | ‘vec4 tmp_output = vec4(out_r, out_g, out_b, 1.0);’ + |
| 21 | ‘gl_FragColor.rgba = tmp_output;’ + |
| 22 | ‘}’; |

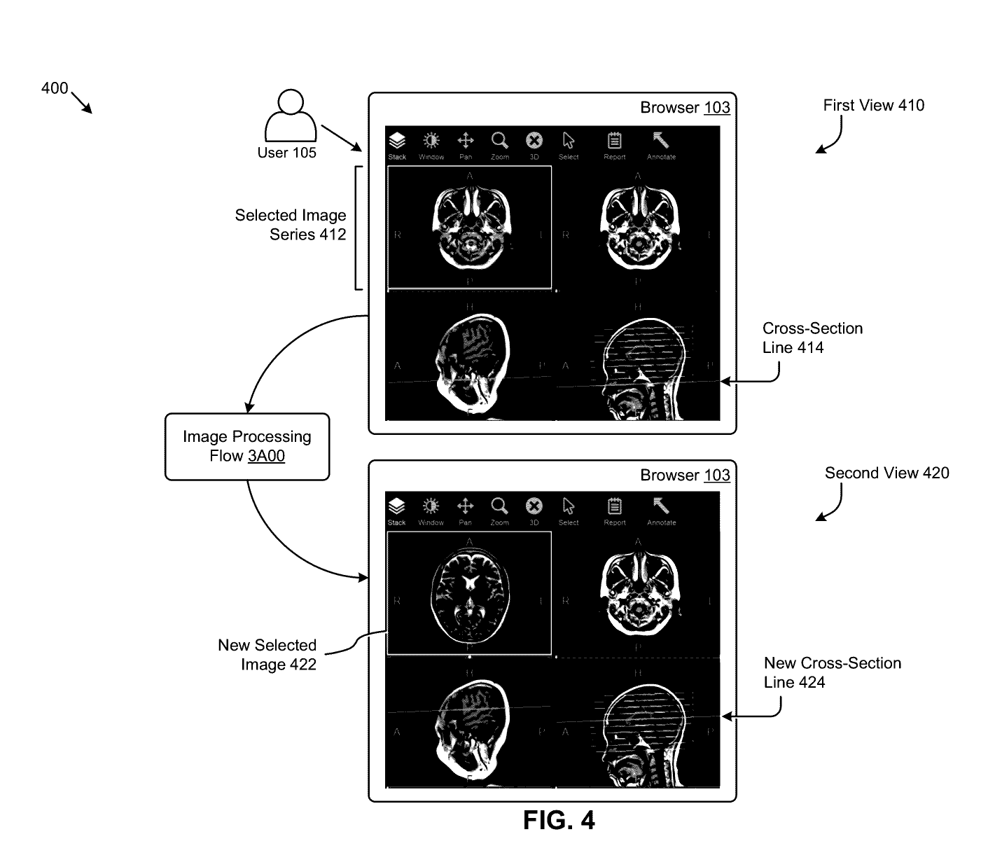

FIG. 4 depicts a user view change operation 400 as invoked in systems for rendering high bit depth grayscale images using GPU color spaces and acceleration. As an option, one or more instances of user view change operation 400 or any aspect thereof may be implemented in the context of the architecture and functionality of the embodiments described herein. Also, the user view change operation 400 or any aspect thereof may be implemented in any desired environment.

The embodiment shown in FIG. 4 depicts a first view 410 in the browser 103 that is changed to a second view 420 in response to a user event, such as a mouse roller turn by the user 105. As shown, in some embodiments, the change from the first view 410 to the second view 420 is enabled in part by the image processing flow 3A00 in the herein disclosed systems for rendering high bit depth grayscale images using GPU color spaces and acceleration. Specifically, the first view 410 shows a selected image series 412 selected by the user 105. The first view 410 further shows a cross-section line 414 in a related image series that is associated with the image shown in the selected image series 412. When the user 105 selects another image in the selected image series 412 (e.g., by rolling the mouse roller wheel), the image processing flow 3A00 and associated system can render a new selected image 422 and a new cross-section line 424 corresponding to the new selected image 422 in the second view 420. As an example, the new selected image 422 and the new cross-section line 424 can be presented in the image layer 372 and the information layer 374, respectively, as described as pertains to FIG. 3B.

Any individual ones or combinations of any of the herein-described techniques can be used for acceleration and rendering on target systems (e.g., user devices) that do not have native support for handling HBD grayscale images (e.g., grayscale images that have a bit depth of more than 8 bits).

### Additional Embodiments of the Disclosure

### Additional Practical Application Examples

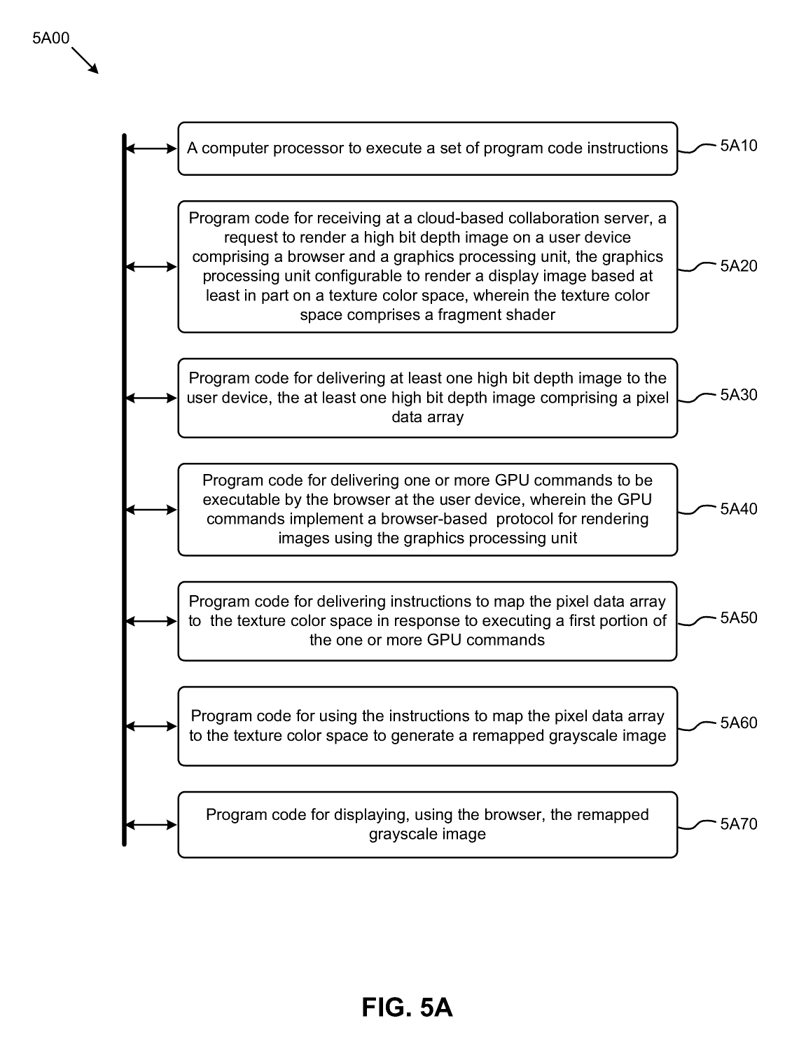

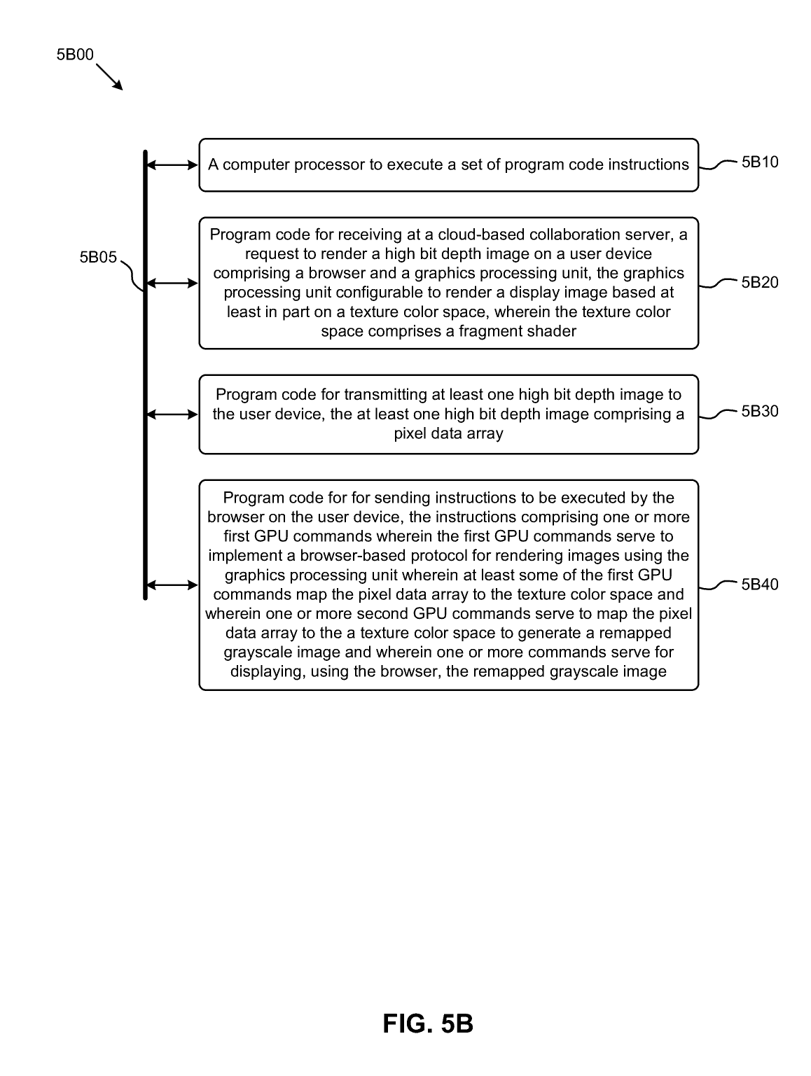

FIG. 5A depicts a system 5A00 as an arrangement of computing modules that are interconnected so as to operate cooperatively to implement certain of the herein-disclosed embodiments. The partitioning of system 5A00 is merely illustrative and other partitions are possible. The system includes processors (see module 5A10) that execute program code for: receiving at a cloud-based collaboration server, a request to render a high bit depth image on a user device comprising a browser and a graphics processing unit, the graphics processing unit configurable to render a display image based at least in part on a texture color space, wherein the texture color space comprises a fragment shader (see module 5A20), program code for delivering at least one high bit depth image to the user device, the at least one high bit depth image comprising a pixel data array (see module 5A30), program code for delivering one or more GPU commands to be executable by the browser at the user device, wherein the GPU commands implement a browser-based protocol for rendering images using the graphics processing unit (see module 5A40), program code for delivering instructions to map the pixel data array to the texture color space in response to executing a first portion of the one or more GPU commands (see module 5A50), program code for using the instructions to map the pixel data array to the texture color space to generate a remapped grayscale image (see module 5A60); and program code for displaying, using the browser, the remapped grayscale image.

FIG. 5B is a block diagram of a system to perform certain functions of a computer system. As an option, the present system 5B00 may be implemented in the context of the architecture and functionality of the embodiments described herein. Of course, however, the system 5B00 or any operation therein may be carried out in any desired environment. The system 5B00 comprises at least one processor and at least one memory, the memory serving to store program instructions corresponding to the operations of the system. As shown, an operation can be implemented in whole or in part using program instructions accessible by a module. The modules are connected to a communication path 5B05, and any operation can communicate with other operations over communication path 5B05. The modules of the system can, individually or in combination, perform method operations within system 5B00. Any operations performed within system 5B00 may be performed in any order unless as may be specified in the claims. The shown embodiment implements a portion of a computer system, presented as system 5B00, comprising a computer processor to execute a set of program code instructions (see module 5B10) and modules for accessing memory to hold program code instructions to perform: receiving at a cloud-based collaboration server, a request to render a high bit depth image on a user device comprising a browser and a graphics processing unit, the graphics processing unit configurable to render a display image based at least in part on a texture color space, wherein the texture color space comprises a fragment shader (see module 5B20); transmitting at least one high bit depth image to the user device, the at least one high bit depth image comprising a pixel data array (see module 5B30). The sending module 5B40 includes program code for sending instructions to be executed by the browser on the user device, the instructions comprising one or more first GPU commands wherein the first GPU commands serve to implement a browser-based protocol for rendering images using the graphics processing unit wherein at least some of the first GPU commands map the pixel data array to the texture color space and wherein one or more second GPU commands serve to map the pixel data array to the texture color space to generate a remapped grayscale image and wherein one or more commands serve for displaying, using the browser, the remapped grayscale image (see module 5B40).

Many variations are possible without departing from the solution. For example, one embodiment receives a request to render a high bit depth (HBD) grayscale image on a user device comprising a GPU (e.g., where the GPU has a color space to natively render grayscale images at a lower bit depth level from the high bit depth grayscale image). The HBD grayscale image (e.g., in a pixel data array), and instructions can be sent to be executed on the user device where some of the instructions serve to operate the GPU (e.g., using WebGL instructions). The instructions can be packaged for transmission. Strictly one such example, an instruction package can comprise one or more first GPU commands wherein the one or more first GPU commands implement a browser-based protocol for rendering images using the GPU, and the one or more first GPU commands to map the pixel data array of the HBD grayscale image to the color space to generate a remapped grayscale image. In exemplary cases the pixel data array of the HBD grayscale image is mapped to a portion of a register or set of registers that comprise a subset of bits associated with the color space. Further, instructions can be packages to cause the GPU to execute one or more commands for displaying the remapped grayscale image.

### System Architecture Overview

### Additional System Architecture Examples

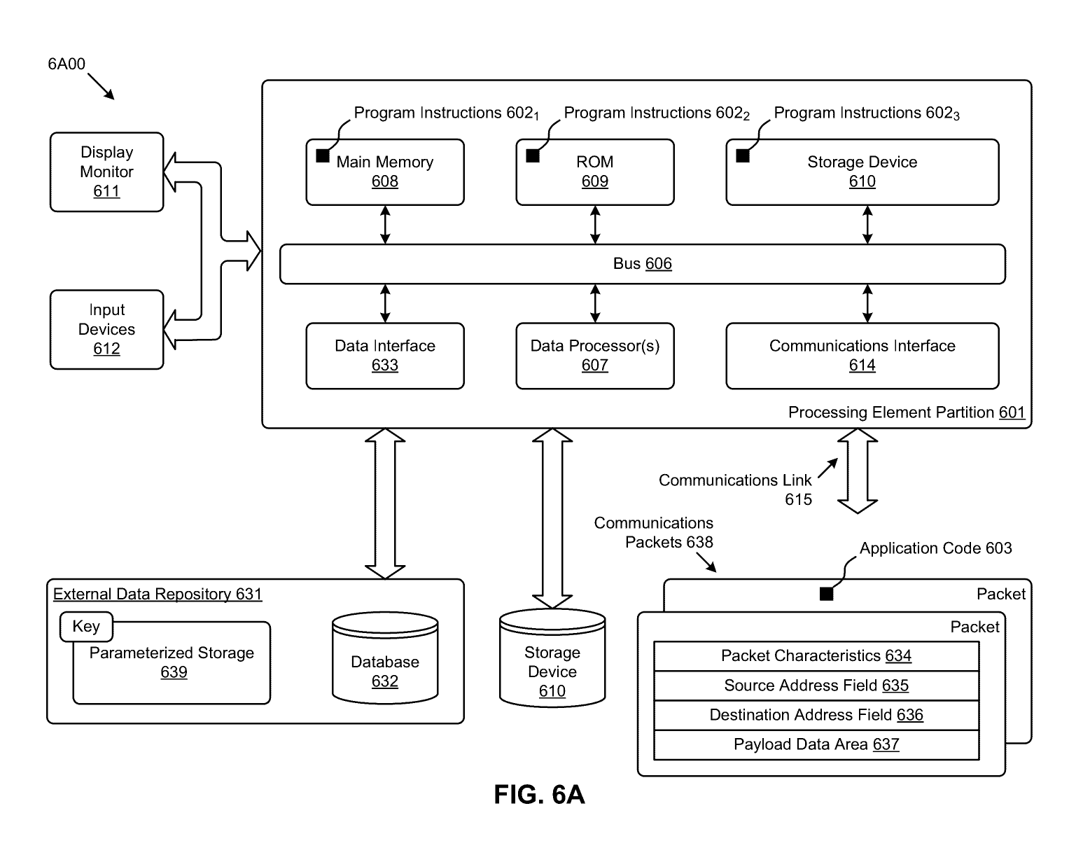

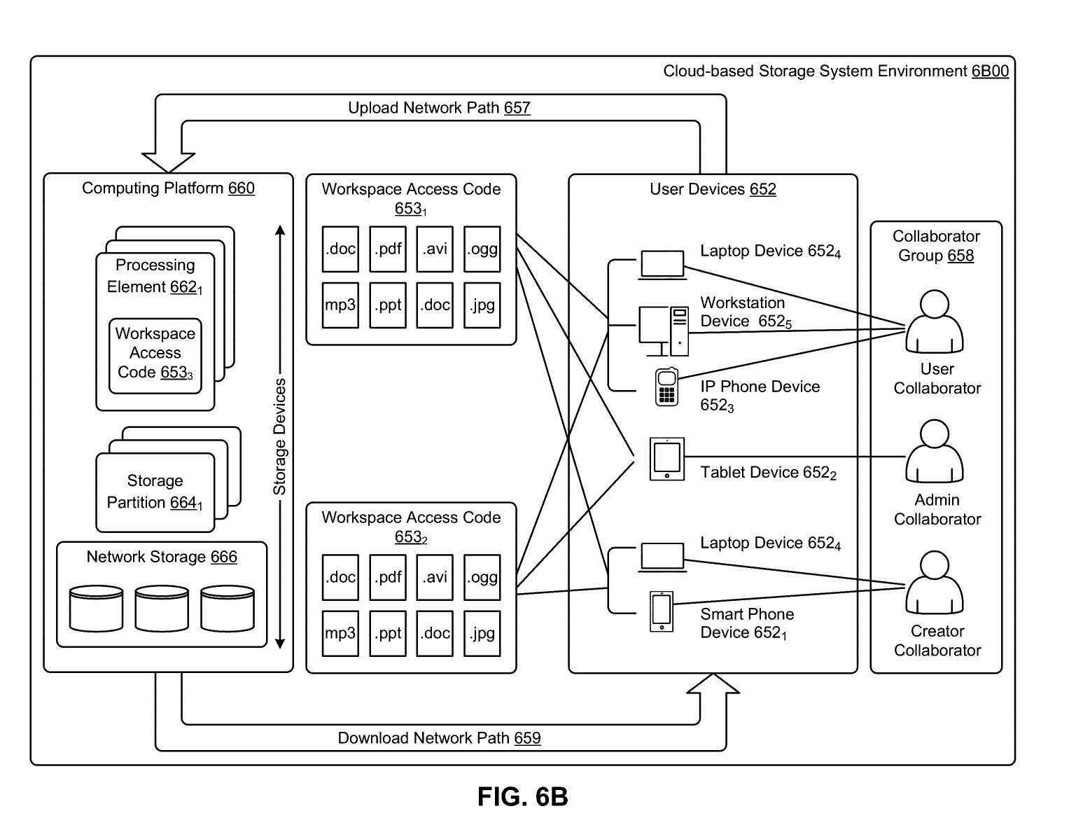

FIG. 6A depicts a block diagram of an instance of a computer system 6A00 suitable for implementing embodiments of the present disclosure. Computer system 6A00 includes a bus 606 or other communication mechanism for communicating information. The bus interconnects subsystems and devices such as a CPU, or a multi-core CPU (e.g., data processor 607), a system memory (e.g., main memory 608, or an area of random access memory RAM), a non-volatile storage device or non-volatile storage area (e.g., ROM 609), an internal or external storage device 610 (e.g., magnetic or optical), a data interface 633, a communications interface 614 (e.g., PHY, MAC, Ethernet interface, modem, etc.). The aforementioned components are shown within processing element partition 601, however other partitions are possible. The shown computer system 6A00 further comprises a display 611 (e.g., CRT or LCD), various input devices 612 (e.g., keyboard, cursor control), and an external data repository 631.

According to an embodiment of the disclosure, computer system 6A00 performs specific operations by data processor 607 executing one or more sequences of one or more program code instructions contained in a memory. Such instructions (e.g., program instructions 602₁, program instructions 602₂, program instructions 602₃, etc.) can be contained in or can be read into a storage location or memory from any computer readable/usable medium such as a static storage device or a disk drive. The sequences can be organized to be accessed by one or more processing entities configured to execute a single process or configured to execute multiple concurrent processes to perform work. A processing entity can be hardware based (e.g., involving one or more cores) or software based, and/or can be formed using a combination of hardware and software that implements logic, and/or can carry out computations and/or processing steps using one or more processes and/or one or more tasks and/or one or more threads or any combination therefrom.

According to an embodiment of the disclosure, computer system 6A00 performs specific networking operations using one or more instances of communications interface 614. Instances of the communications interface 614 may comprise one or more networking ports that are configurable (e.g., pertaining to speed, protocol, physical layer characteristics, media access characteristics, etc.) and any particular instance of the communications interface 614 or port thereto can be configured differently from any other particular instance. Portions of a communication protocol can be carried out in whole or in part by any instance of the communications interface 614, and data (e.g., packets, data structures, bit fields, etc.) can be positioned in storage locations within communications interface 614, or within system memory, and such data can be accessed (e.g., using random access addressing, or using direct memory access DMA, etc.) by devices such as data processor 607.

The communications link 615 can be configured to transmit (e.g., send, receive, signal, etc.) any types of communications packets 638 comprising any organization of data items. The data items can comprise a payload data area 637, a destination address 636 (e.g., a destination IP address), a source address 635 (e.g., a source IP address), and can include various encodings or formatting of bit fields to populate the shown packet characteristics 634. In some cases the packet characteristics include a version identifier, a packet or payload length, a traffic class, a flow label, etc. In some cases the payload data area 637 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 607 for execution. Such a medium may take many forms including, but not limited to, non-volatile media and volatile media. Non-volatile media includes, for example, optical or magnetic disks such as disk drives or tape drives. Volatile media includes dynamic memory such as a random access memory.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 631, which in turn can be formatted into any one or more storage areas, and which can comprise parameterized storage 639 accessible by a key (e.g., filename, table name, block address, offset address, etc.).

Execution of the sequences of instructions to practice certain embodiments of the disclosure are performed by a single instance of the computer system 6A00. According to certain embodiments of the disclosure, two or more instances of computer system 6A00 coupled by a communications link 615 (e.g., LAN, PTSN, or wireless network) may perform the sequence of instructions required to practice embodiments of the disclosure using two or more instances of components of computer system 6A00.

The computer system 6A00 may transmit and receive messages such as data and/or instructions organized into a data structure (e.g., communications packets 638). The data structure can include program instructions (e.g., application code 603), communicated through communications link 615 and communications interface 614. Received program code may be executed by data processor 607 as it is received and/or stored in the shown storage device or in or upon any other non-volatile storage for later execution. Computer system 6A00 may communicate through a data interface 633 to a database 632 on an external data repository 631. Data items in a database can be accessed using a primary key (e.g., a relational database primary key).

The processing element partition 601 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 607. Some embodiments include one or more special-purpose hardware components (e.g., power control, logic, sensors, transducers, etc.). A module may include one or more state machines and/or combinational logic used to implement or facilitate the performance characteristics of rendering high bit depth grayscale images using GPU color spaces and acceleration.

Various implementations of the database 632 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of rendering high bit depth grayscale images using GPU color spaces and acceleration). Such files or records can be brought into and/or stored in volatile or non-volatile memory.

FIG. 6B depicts a block diagram of an instance of a cloud-based storage system environment 6B00. Such a cloud-based storage system environment supports access to workspaces through the execution of workspace access code (e.g., workspace access code 653₁ and workspace access code 653₂. Workspace access code can be executed on any of the shown user devices 652 (e.g., laptop device 652₄, workstation device 652₅, IP phone device 652₃, tablet device 652₂, smart phone device 652₁, etc.). A group of users can form a collaborator group 658, and a collaborator group can be comprised of any types or roles of users. For example, and as shown, a collaborator group can comprise a user collaborator, an administrator collaborator, a creator collaborator, etc. Any user can use any one or more of the user devices, and such user devices can be operated concurrently to provide multiple concurrent sessions and/or other techniques to access workspaces through the workspace access code.

A portion of workspace access code can reside in and be executed on any user device. Also, a portion of the workspace access code can reside in and be executed on any computing platform (e.g., computing platform 660), including in a middleware setting. As shown, a portion of the workspace access code (e.g., workspace access code 653₃) resides in and can be executed on one or more processing elements (e.g., processing element 662₁). The workspace access code can interface with storage devices such the shown networked storage 666. Storage of workspaces and/or any constituent files or objects, and/or any other code or scripts or data can be stored in any one or more storage partitions (e.g., storage partition 664₁). In some environments, a processing element includes forms of storage, such as RAM and/or ROM and/or FLASH, and/or other forms of volatile and non-volatile storage.

A stored workspace can be populated via an upload (e.g., an upload from a user device to a processing element over an upload network path 657). One or more constituents of a stored workspace can be delivered to a particular user and/or shared with other particular users via a download (e.g., a download from a processing element to a user device over a download network path 659).

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings to be regarded in an illustrative sense rather than in a restrictive sense.

What is claimed is:

1. A method comprising:
receiving at a cloud-based collaboration server, a request to render a high bit depth (HBD) grayscale image on a user device comprising a graphics processing unit (GPU), the GPU having a color space to natively render grayscale images at a lower bit depth level from the high bit depth grayscale image;
transmitting the HBD grayscale image to the user device, the HBD grayscale image comprising a pixel data array; and
sending instructions to be executed on the user device, the instructions comprising:
one or more first GPU commands wherein the one or more first GPU commands implement a browser-based protocol for rendering images using the GPU, and the one or more first GPU commands to map the pixel data array of the HBD grayscale image to the color space to generate a remapped grayscale image, wherein the pixel data array of the HBD grayscale image is mapped within a subset of bits associated with the color space; and
one or more commands for displaying the remapped grayscale image.

2. The method of claim 1, further comprising a fragment shader having attributes that describe a window center associated with the high bit depth image and a window width associated with the high bit depth image.

3. The method of claim 2, further comprising extrapolating a window resolution range to a display resolution range, wherein the window resolution range associated with the window center and the window width.

4. The method of claim 1, wherein the color space describes a reference to at least one of, an RGB color space, an RGBA color space, a CMYK color space, or any combination therefrom.

5. The method of claim 4, wherein the pixel data array comprises at least one 16-bit word and the color space comprises at least one 24-bit color component row, and wherein the at least one 16-bit word is mapped to a portion of the 24-bit color component row.

6. The method of claim 1, wherein the browser-based protocol for rendering images comprises one or more WebGL commands.

7. The method of claim 1, wherein the grayscale image comprises an image layer and an information layer.

8. The method of claim 1, wherein the grayscale image is in a medical image.

9. The method of claim 8, wherein the medical image is an MRI image.

10. The method of claim 8, wherein the medical image is in a DICOM file format.

11. A computer program product, embodied in a non-transitory computer readable medium, the computer readable medium having stored thereon a sequence of instructions which, when executed by a processor causes the processor to execute a process, the process comprising:
receiving at a cloud-based collaboration server, a request to render a high bit depth (HBD) grayscale image on a user device comprising a graphics processing unit (GPU), the GPU having a color space to natively render grayscale images at a lower bit depth level from the high bit depth grayscale image;
transmitting the HBD grayscale image to the user device, the HBD grayscale image comprising a pixel data array; and
sending instructions to be executed on the user device, the instructions comprising:
one or more first GPU commands wherein the one or more first GPU commands implement a browser-based protocol for rendering images using the GPU, and the one or more first GPU commands to map the pixel data array of the HBD grayscale image to the color space to generate a remapped grayscale image, wherein the pixel data array of the HBD grayscale image is mapped within a subset of bits associated with the color space; and
one or more commands for displaying the remapped grayscale image.

12. The computer program product of claim 11, further comprising instructions or code to implement a fragment shader having attributes that describe a window center associated with the high bit depth image and a window width associated with the high bit depth image.

13. The computer program product of claim 12, further comprising instructions for extrapolating a window resolution range to a display resolution range, wherein the window resolution range associated with the window center and the window width.

14. The computer program product of claim 11, wherein the color space describes a reference to at least one of, an RGB color space, an RGBA color space, a CMYK color space, or any combination therefrom.

15. The computer program product of claim 14, wherein the pixel data array comprises at least one 16-bit word and the color space comprises at least one 24-bit color component row, and wherein the at least one 16-bit word is mapped to a portion of the 24-bit color component row.

16. The computer program product of claim 11, wherein the browser-based protocol for rendering images comprises one or more WebGL commands.

17. The computer program product of claim 11, wherein the grayscale image comprises an image layer and an information layer.

18. The computer program product of claim 11, wherein the grayscale image is in a medical image.

19. A system comprising:
a cloud-based collaboration server, to receive a request to render a high bit depth (HBD) grayscale image on a user device comprising a graphics processing unit (GPU), the GPU having a color space to natively render grayscale images at a lower bit depth level from the high bit depth grayscale image;
a network port to transmit the HBD grayscale image to the user device, the HBD grayscale image comprising a pixel data array; and
a sending module to send instructions to be executed on the user device, the instructions comprising:
one or more first GPU commands wherein the one or more first GPU commands implement a browser-based protocol for rendering images using the GPU, and the one or more first GPU commands to map the pixel data array of the HBD grayscale image to the color space to generate a remapped grayscale image, wherein the pixel data array of the HBD grayscale image is mapped within a subset of bits associated with the color space; and
one or more commands for displaying the remapped grayscale image.

20. The system of claim 19, further comprising a fragment shader having attributes that describe a window center associated with the high bit depth image and a window width associated with the high bit depth image.
